(19) United States
(12) Patent Application Publication
(10) Pub. No.: US 2004/0170218 A1
(43) Pub. Date: Sep. 2, 2004

(54) Rake receiver for ultra wide bandwidth communications systems

(76) Inventors: Andreas Molisch, North Plainfield, NJ (US); Giovanni Vannucci, Red Bank, NJ (US); Jinyun Zhang, New Providence, NJ (US)

Correspondence Address: Patent Department, Mitsubishi Electric Research Laboratories, Inc., 201 Broadway, Cambridge, MA, 02139, US

(21) Appl. No.: 10/376,686

(22) Filed: Mar. 1, 2003

(51) Int. Cl. H04K 1/00

(52) U.S. Cl. 375/147

(57) ABSTRACT

A rake receiver detects a transmitted ultra wide bandwidth radio signal. The receiver includes a front end for converting a received version of the transmitted radio signal into an electrical signal. Multiple rake fingers process the electrical signal in parallel. Each rake finger includes the following components that can be connected serially in an arbitrary order. A programmable pulse generator generates a sequence of pulses. A multiplier connected to an output of the front end and to an output of a programmable pulse generator generates a signal functionally related to a product of the output of the front end and the output of the programmable pulse generator. A low-pass filter to filter an output of the multiplier, and an adjustable weight block scale an output of the low-pass filter. In addition the rake receiver includes a pulse sequence controller to adjust a timing of each sequence of pulses from each programmable pulse generator in each rake finger, and a weight controller to adjust weights for each adjustable weight block in each rake finger. A summing block combines the outputs of the rake fingers to recover a signal corresponding to the transmitted radio signal.

### FIELD OF INVENTION

The present invention relates generally to the field of wireless radio communications, and more specifically to rake receivers for ultra wide bandwidth radio systems.

### BACKGROUND OF THE INVENTION

Ultra wide bandwidth (UWB) is a form of spread-spectrum radio communication. In UWB systems, the bandwidth is much wider than the bandwidth of the underlying payload or data signal. However, unlike a conventional spread-spectrum system, where the signal is, more or less, of constant amplitude, a UWB signal consists of a sequence of very short pulses spread over a very wide frequency range. Therefore, the terms “UWB” and “impulse radio” are often used synonymously. The spreading waveform is a pattern of short pulses that is modulated to encode the data.

Many spread-spectrum communication systems employ so-called “rake” receivers to compensate for multi-path propagation.

FIG. 1 shows a rake receiver 100 according to the prior art. The rake receiver includes a front end 101 for pre-processing a radio signal 102. The rake receiver has a modular structure wherein the received radio signal 102 is processed in parallel through multiple rake fingers 110. Each rake finger 110 processes the signal that is received through one of the paths of propagation in a multi-path radio channel.

Accordingly, each finger includes an adjustable delay block 111 controlled by a delay controller 120, and an adjustable weight block 114 controlled by a weight controller 140 for signal gain. The delayed received signal is multiplied 112 by a de-spreading waveform output from a de-spreading waveform generator 130, low-pass filtered 113, before the signals are scaled or weighted 114.

The delay and weight gain compensate respectively for delay and attenuation of the corresponding path. Each finger extracts the corresponding path signal by “de-spreading” the received signal through the multiplication 112 by a replica of the spreading waveform that was used in the transmitter. The outputs of the fingers 110 are then combined in a summing block 150 before post-processing (PP) 160. The summing can be an algebraic sum.

More specifically, processing is usually performed on a complex representation of the received signal 102, whereby each signal corresponds to a complex waveform consisting of a real and imaginary part, also known as in-phase and quadrature components. The weight of each rake finger 110 is set to match the complex conjugate of the complex amplitude of the corresponding path.

When the outputs of the fingers are combined in the summing block Σ 150, they are simply added together. This method of weighting and combining multiple signals is known as “maximal-ratio” combining. Alternative methods for the choice of the finger weights include “equal gain” weight assignment and “optimum” weight generation.

One problem with a conventional rake receiver is that the adjustable delay blocks 111 are difficult to implement for a UWB signal.

Due to the ultra wide bandwidth, UWB systems have a very fine temporal resolution, and are thus capable of resolving multi-path components that are spaced at an inverse of the bandwidth. This is usually seen as a big advantage of UWB. Multi-path resolution of components reduces signal fading because the multi-path components are different diversity paths. The probability that the components are simultaneously all in a deep fade is very low.

However, the fine time resolution also means that many of the multi-path components (MPC) have to be “collected” by the rake receiver 100 in order obtain all of the available energy. A channel with Nₚ resolvable components requires Nₚ fingers to collect all of the available energy. In a dense multi-path environment, the number of MPC increases linearly with the bandwidth. For example, a UWB system with a 10 GHz bandwidth, operating in an environment with 100 ns maximum excess delay requires 1000 fingers. Even a sparse environment, such as specified by the IEEE 802.15.3a standard channel model, requires up to 80 fingers to collect 80% of the available energy.

Another problem is the complexity of the rake fingers 110. In the conventional rake finger of a direct-sequence-spread spectrum (DS-SS) system, the output of the correlator is determined once per symbol. In order to do the correlation, the signal first has to be sampled and analog-to-digital (A/D) converted at the chip rate, which is the inversion of the spreading bandwidth. Then, those samples have to be processed. This involves convolution with the stored reference waveform, addition, and readout. Sampling and A/D converting at the chip rate, e.g., 10 GHz, requires expensive components.

The goal of UWB is to enable low cost and ultra high data rate applications. To make UWB feasible for these types of applications an improved rake receiver that overcomes the above problems is desired.

### SUMMARY OF THE INVENTION

The invention provides a rake receiver for ultra wide bandwidth (UWB) communications systems. After processing a received UWB radio signal in a front-end, the UWB signal is passed in parallel through multiple rake fingers.

The number of fingers is based on the number of “significant” paths in a transmission channel, as well as cost considerations.

Each finger includes a programmable pulse generator, a multiplier, a low-pass filter, and an adjustable weight serially connected, perhaps in an arbitrary order. The programmable pulse generator generates a pulse waveform with a delay corresponding to a delay of a particular path in the multi-path channel.

The pulse waveform is multiplied with the received signal in the analog domain, and sampled and A/D converted at the symbol rate. The output signal is then low-pass filtered and gain controlled with an adjusted weight. Finally, the outputs from all of the fingers are combined by summation to recover the transmitted signal.

### BRIEF DESCRIPTION OF THE DRAWINGS

FIG. 1 is a block diagram of a prior art rake receiver for a spread-spectrum ultra wide bandwidth communication system;

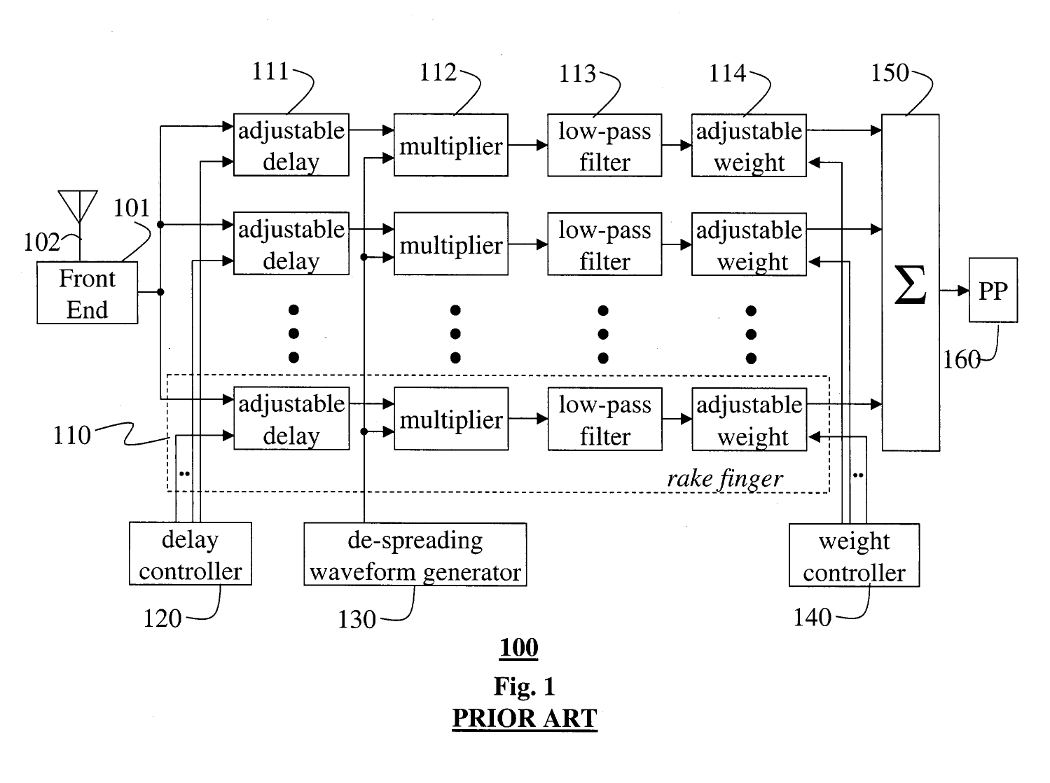

FIG. 2 is a block diagram of a rake receiver according to the invention;

FIG. 3 is block diagram of an alternative embodiment of the rake receiver according to the invention; and

FIG. 4 is a block diagram of yet another alternative embodiment of the rake receiver according to the invention.

### DETAILED DESCRIPTION OF THE PREFERRED EMBODIMENT

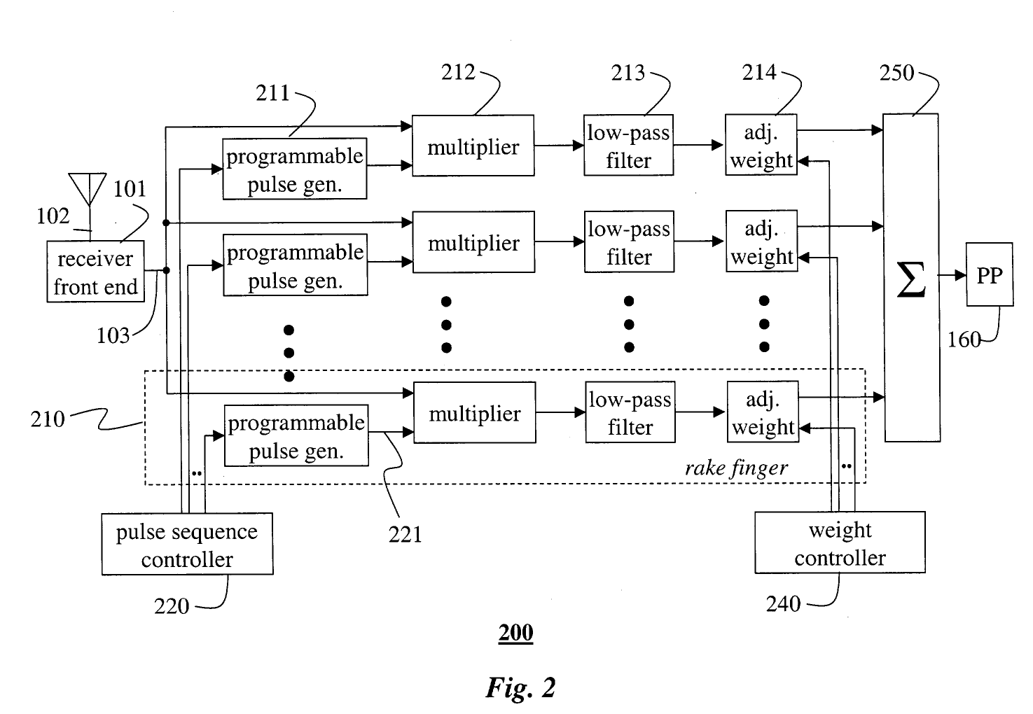

FIG. 2 shows a rake receiver 200 for an ultra wide bandwidth communications system according to the invention. The receiver 200 includes a front end 101 for pre-processing a received radio signal 102. The front end converts the received signal 102 to an electrical signal 103 that is a complex signal including an in-phase component and a quadrature component. In one embodiment the electrical signal 103 is in digital form. In another embodiment, the received radio signal 102 is a real, baseband radio signal and is converted to real, electrical baseband signal.

The rake receiver 200 has a modular structure wherein the received radio signal 102 is processed in parallel through multiple channels known as “rake fingers” 210. Each rake finger 210 processes the signal that is received through one of the paths of propagation in a multi-path radio channel.

Accordingly, each finger includes a programmable pulse generator 211 controlled by a pulse sequence controller 220. A multiplier 212 takes as input the electrical signal 103 and the output of the programmable pulse generator 211. The output of the multiplier 212 is low-pass filtered 213. The low-pass filter generates an output proportional to a time integral of an input to the filter. The filter can be an integrate-and-dump filter.

Then, the signal is weighted 214 according to a weight controller 240 for signal gain to compensate for attenuation in the multi-path cannel. The outputs of the fingers 210 are then combined in a summing block 250 before post-processing (PP) 160. This method of weighting and combining multiple signals is known as “maximal-ratio” combining. Alternative methods for the choice of the finger weights include “equal gain” weight assignment, and “optimum” weight generation.

The difference between the rake receiver 200 according to the invention and the prior art rake receiver 100 is that the adjustable delay blocks 211 and the delay controller 120 have been eliminated, and the single de-spreading waveform generator 130 has been replaced by a plurality of programmable pulse generators 220, one for each rake finger 210.

These modifications are advantageous because the prior art adjustable delay blocks are difficult to implement for the ultra wideband signal, while the programmable pulse generators 211 are much easier to implement with integrated electronic circuits.

All of the programmable pulse generators 211 produce a pulse pattern 221. The pulse pattern is identical to a pulse pattern that is used in the transmitter to module data to be transmitted. However, the timings of the pulse patterns from the different pulse generators 211 are different. The pulse sequence controller 220 adjusts the timing of each pulse generator to match the delay of one path in the multi-path channel.

The rake receiver 200 according to the invention exploits the sparsity of the channel. The number of “significant” paths in the IEEE802.15.3a channel models, i.e., those channels that capture 85% of the energy, lies between 40 for the UWB indoor channel model 1 (CM1), and 160 for the UWB indoor channel model 4 (CM4). Thus, it is not necessary to A/D convert all of the approximately two thousand possible paths, i.e., pulses with 200 ns duration and an impulse response with 100 ps delay resolution.

After the channel is estimated, the most significant paths are identified. The number of fingers 210 is then reduced to match the number of the significant paths. Trading off performance for cost can use fewer fingers.

As described above, the pulse sequence controller 220 adjusts the timing out of each pulse generator 211 to match the delay of each significant path in the channel.

The performance of the modified rake receiver of FIG. 2 is close to that of the prior-art rake receiver, as long as the symbol rate of the payload signal is small compared to the delay spread of the channel.

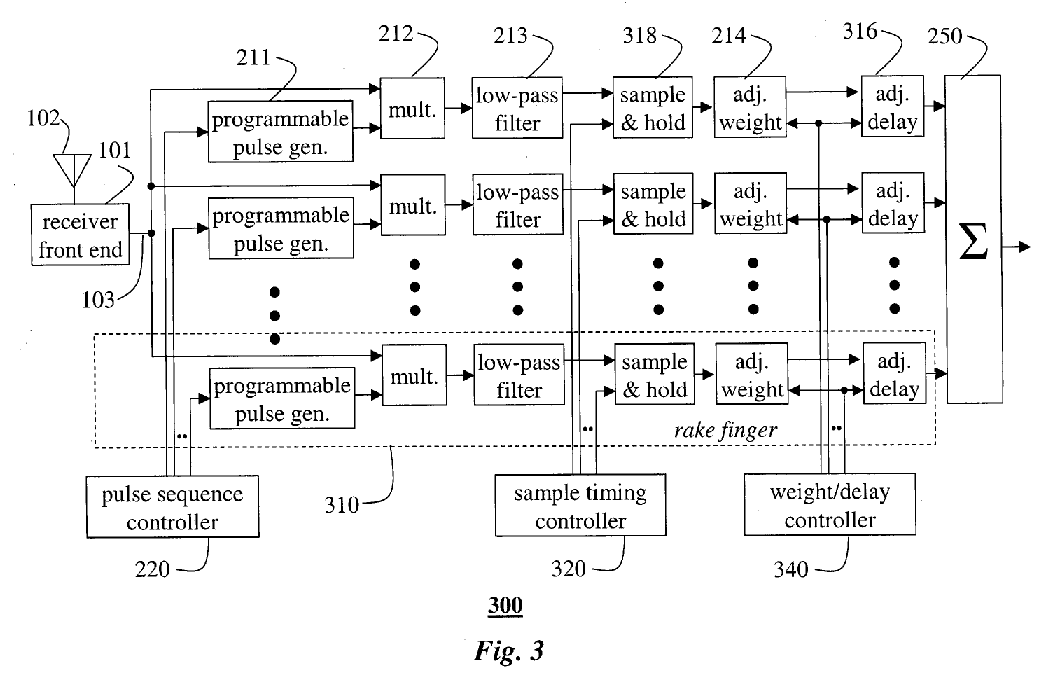

FIG. 3 shows an alternative receiver 300 for situations where this symbol rate condition is not met. The performance for the receiver 300 is the same as for the prior-art rake receiver 100. The adjustable delay blocks that were removed from the receiver 200, are re-introduced as adjustable delay blocks 216 in each rake finger 310.

However, in this embodiment, the delay block 216 is arranged as the last functional block in the finger 310. This makes the delays much easier to implement because the signal bandwidth at this point is much narrower than before the low-pass filter 213. The blocks 216 are shown with a dashed outline to indicate that they are optional.

Each finger 310 also includes a sample-and-hold block 318. Again, the dashed outline indicates that the blocks 318 are also optional. These blocks make it easier to implement the adjustable weight blocks 214 and the adjustable delay blocks 216 that follow in the finger. This is especially true when the sample-and-hold blocks 218 are implemented as A/D converters, so that all functions that follow can be implemented digitally. The adjustable weight and delay blocks are controlled by a weight and delay controller 340.

In this case, the sampling is at the symbol rate. The adjustable delay blocks 316 only need coarse adjustment, while fine timing adjustments are performed by a sample timing controller 320 through precise adjustments of the individual sampling times.

Other embodiments are also possible. In particular, the last four functional blocks 213, 214, 216, and 218 in each rake 310 can be connected serially in each finger in any arbitrary order without affecting the functionality of the receiver 300. FIG. 3 shows the preferred order.

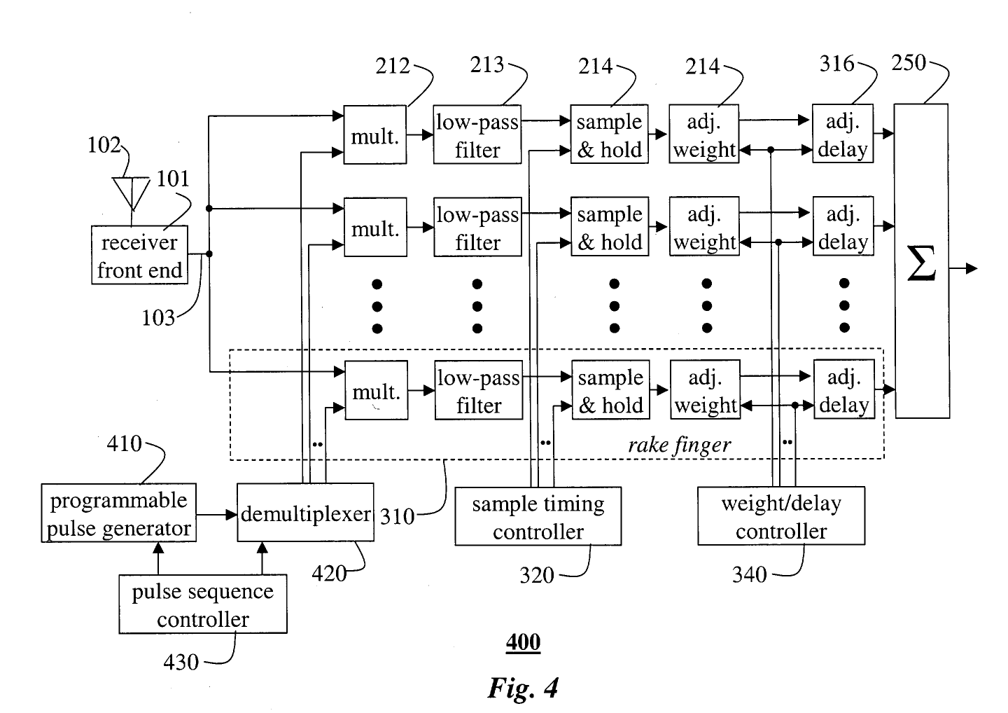

FIG. 4 shows another alternative embodiment of a rake receiver 400. In the receiver 400, the individual programmable pulse generators 211 are replaced by a single pulse generator 410 followed by a demultiplexer 420, and a pulse sequence controller 430. This is advantageous in some applications where the multiple pulse generators 211 are difficult to implement, while the single pulse generator 410 and the demultiplexer 420 are relatively easy to implement.

The demultiplexer 420 operates as a switch to route the pulses from the pulse generator 410 to the various multipliers 212 according to a pattern defined by the pulse sequence controller 430. Concurrently, the controller 430 also controls the pattern of pulses generated by the programmable pulse generator 410, so as to achieve the desired patterns of pulses for the multipliers 212.

In the above description, all the rake fingers receive the same pulse pattern with different timings. However, the invention also allows the option of feeding different pulse patterns to different rake fingers. This can be particularly advantageous in situations with severe multi-path, where the harm of inter-symbol interference can be larger than the advantage of additional detected signal.

In general, the pulse sequence controller, sample timing controller and weight/delay controller work in concert to optimize the performance of the rake receiver for the available channel, while fully exploiting the flexibility afforded by our invention.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. An apparatus for detecting a transmitted radio signal, comprising:
a front end to convert a received version of the transmitted radio signal into an electrical signal;
a plurality of rake fingers, each rake finger to process the electrical signal in parallel, and each rake finger further comprising:
a programmable pulse generator to generate a sequence of pulses;
a multiplier connected to an output of the front end and to an output of a programmable pulse generator to generate a signal functionally related to a product of the output of the front end and the output of the programmable pulse generator;
a low-pass filter to filter an output of the multiplier; and
an adjustable weight block to scale an output of the low-pass filter; and
a pulse sequence controller to adjust a timing of each sequence of pulses from each programmable pulse generator in each rake finger;
a weight controller to adjust weights for each adjustable weight block in each rake finger; and
a summing block is configured to combine an output of each rake finger to recover a signal corresponding to the transmitted radio signal.

2. The apparatus of claim 1 wherein the transmitted radio signal is an ultra wide bandwidth signal.

3. The apparatus of claim 1 wherein a pattern of the sequence of pulses is identical to a pattern of pulses used to spread the transmitted signal in a transmitter.

4. The apparatus of claim 1 wherein the timing of each sequence of pulses match a delay of one path in a multi-path channel used to transmit the radio signal.

5. The apparatus of claim 1 wherein the low-pass filter generates an output proportional to a time integral of an input to the low-pass filter.

6. The apparatus of claim 1 wherein:
the low-pass filter is an integrate-and-dump filter.

7. The apparatus of claim 1 wherein the electrical signal is a complex signal consisting of an in-phase component and a quadrature component.

8. The apparatus of claim 4 wherein the electrical signal is in a form of a digital signal.

9. The apparatus of claim 1 wherein the programmable pulse generator, the multiplier, the low-pass filter, and the adjustable weight block are connected serially in each rake finger in an arbitrary order.

10. The apparatus of claim 1 further comprising:
an adjustable delay block connected between the low-pass filter and the summing block.

11. The apparatus of claim 10 wherein the sample-and-hold block is an analog-to-digital converter.

12. The apparatus of claim 1 further comprising:
An adjustable-delay unit adapted to generate an output signal proportional to a delayed version of an input signal, with the delay value determined by a control input.

13. The apparatus of claim 1 wherein the radio signal is an ultra wide bandwidth signal.

14. An apparatus for detecting a transmitted radio signal, comprising:
a front end to convert a received version of the transmitted radio signal into an electrical signal;
a programmable pulse generator to generate a sequence of pulses;
a demultiplexer connected to an output of the programmable pulse generator to generate a plurality of the sequence of pulses;
a pulse sequence controller to adjust a timing of each sequence of pulses;
a plurality of rake fingers, each rake finger to process the electrical signal in parallel, and each rake finger further comprising:
a multiplier connected to an output of the front end and to an output of the demultiplexer to generate a signal functionally related to a product of the output of the front end and the output of the programmable pulse generator;
a low-pass filter to filter an output of the multiplier; and
an adjustable weight block to scale an output of the low-pass filter; and
a weight controller to adjust weights for each adjustable weight block in each rake finger; and
a summing block configured combine an output of each rake finger to recover a signal corresponding to the transmitted radio signal.

15. A method for detecting a transmitted radio signal, comprising:
converting a received version of the transmitted radio signal into an electrical signal;
processing the electrical signal in parallel in a plurality of rake fingers, the parallel processing further comprising:
generating a sequence of pulses with adjustable timing;
multiplying the sequence of pulses with the electrical signal;
low-pass filtering a signal produce by the multiplying;
scaling the filtered signal by an adjustable weight; and
summing the scaled signal to recover a signal corresponding to the transmitted radio signal.
